(19) United States
(12) Patent Application Publication
(10) Pub. No.: US 2018/0237601 A1
(43) Pub. Date: Aug. 23, 2018

(54) HEAT STABILIZED LONG FIBER POLYAMIDE POLYMER COMPOSITIONS AND CORRESPONDING FABRICATION METHODS AND ARTICLES

(71) Applicant: SOLVAY SPECIALTY POLYMERS USA, LLC, Alpharetta, GA (US)

(72) Inventors: Thorsten WINDHUES, Oberhausen (DE); Geert J. VERFAILLIE, Parike (BE)

(21) Appl. No.: 15/959,724

(22) Filed: Apr. 23, 2018

(51) Int. Cl. C08J 5/04; C08K 7/14; C08K 5/053; C08K 5/06; C08K 5/1545; C08K 3/08

(52) U.S. Cl. CPC C08J 5/043; C08K 7/14; C08K 5/053; C08K 2003/0856; C08K 5/1545; C08K 3/08; C08J 2377/00; C08K 5/06

(57) ABSTRACT

Described herein are polyamide polymer compositions including a polyamide polymer, a long reinforcing fiber, and a heat stabilizer. Optionally, the polyamide polymer composition can further include an additive. The polyamide polymer compositions are selectively engineered to leverage improved heat stabilization and improved mechanical performances to synergistically improve the high temperature performance of the polyamide polymer composition. The polyamide polymer compositions can be advantageously incorporated into articles used in high temperature applications settings, at least in part due to the synergistically improved high temperature performance.

### FIELD OF THE INVENTION

The invention relates to polyamide polymer compositions including long reinforcing fibers and a heat stabilizer. The invention further relates to articles including the aforementioned polyamide polymer composition.

### BACKGROUND OF THE INVENTION

Polyamides are widely used in structural applications due to their excellent mechanical properties. Long fiber reinforcements (e.g. glass fiber and carbon fiber) can be used to provide further improvements in polyamide polymer composition strength and, therefore, increase the range of application into which long fiber reinforced polyamide compositions can be introduced. Nevertheless, the thermal properties of the aforementioned compositions limit significantly limit their use in a number of significant application settings.

### BRIEF DESCRIPTION OF THE DRAWINGS

FIG. 1 is a schematic representation of the cross-section of a glass fiber, depicting the aspect ratio.

### DETAILED DESCRIPTION OF THE INVENTION

Described herein are polyamide polymer compositions including a polyamide polymer, a long reinforcing fiber, and a heat stabilizer. Optionally, the polyamide polymer composition can further include additives. The polyamide polymer composition are selectively engineered to leverage improved heat resistance and improved mechanical performances, to synergistically improve the high temperature performance of the polyamide polymer composition. The polyamide polymer compositions can be advantageously incorporated into articles used in high temperature applications settings, at least in part due to the synergistically improved high temperature performance.

The polyamide polymer compositions described herein include a specifically engineered combination of selected heat stabilizers and selected mechanical reinforcements to provide synergistically improved high heat performance. There is an ever present need to increase the mechanical performance of polyamide polymer compositions in high temperature (>180° C.) application settings. For example, in the automotive application setting, engine sizes are being reduced, and operating temperatures increased, in order to decrease both CO₂ emissions and fuel consumption. As the demand for reduced emissions and fuel consumption increases, polymeric parts in contact with the engine environment are required to maintain or increase mechanical performance at even higher temperatures. For example, in under the hood automotive application settings, polymeric components having high mechanical performance at temperatures above 200° C. are desired.

Traditional approaches to increase the heat stability are not sufficient in maintaining the mechanical performance of polyamide polymer compositions at higher operating temperatures described above. Traditional methods involve the use of copper based systems like Cu/KI in short-fiber reinforced polyamide polymer compositions to improve the thermo-oxidative stability of the polyamide polymer, as explained in detail below. In general, the stabilizer helps to deactivate free radicals generated and slow down the autocatalytic degradation mechanism during thermal ageing.

Heat stabilization packages including, but not limited to, polyhydric alcohols and elemental iron, were developed and introduced to increase the heat resistance of polyamides at temperature above 200° C. Now, however, the limiting factor is the mechanical performance at temperatures about 200° C. While short reinforcing fiber reinforced compound are used to increase the rigidity and strength of the polyamide polymer compositions, at temperatures at or above about 190° C., it was found that the polyamide delaminates from the reinforcing fiber and the mechanical strengths (e.g. rigidity and strength) decrease significantly. By using long reinforcing fibers, the performance of materials is improved. The polyamide polymer compositions described herein have desirable mechanical properties at temperatures at or above 200° C. In short fiber reinforced polyamide polymer compositions, the mechanical properties are mainly polymer controlled. More specifically, while the short reinforcing fibers provide some element of mechanical stability, the mechanical properties of the polymer itself are largely controlling (“polymer controlled structure”). By using long reinforcing fibers, a three dimensional fiber structure can be formed through fiber interaction with the polymer. In such a case, fiber structure largely controls the mechanical properties and provides significantly increased rigidity and strength, relative to corresponding short fiber reinforced polyamide polymer compositions.

Furthermore, due to the presences of the heat stabilizer, the mechanical properties of the polyamide polymer composition are synergistically increased at temperatures at or about 200° C.

### The Polyamide Polymer

The polyamide polymer composition includes a polyamide polymer. As used herein, a polyamide polymer refers to any polymer including more than 50 mole percent (“mol %”) of a recurring unit (R_{PA}) having at least one amide group (—C(═O)—NH—). In some embodiments, the polyamide has at least 60 mol %, preferably at least 70 mol %, more preferably at least 80 mol %, even more preferably at least 90 mol %, most preferably at least 99 mol % of recurring unit (R_{PA}), relative to the total number of moles of recurring units in the polyamide polymer. In some embodiments, the concentration of recurring unit (R_{PA}) is more than 50 mol % to no more than 99 mol %, relative to the total number of moles of recurring units in the polyamide polymer. The person of ordinary skill in the art will recognize that additional concentration ranges of recurring unit (R_{PA}) within the specifically described ranges are contemplated and within the scope of the present disclosure.

In some embodiments, recurring unit (R_{PA}) is represented by a formula selected from the following group of formulae:

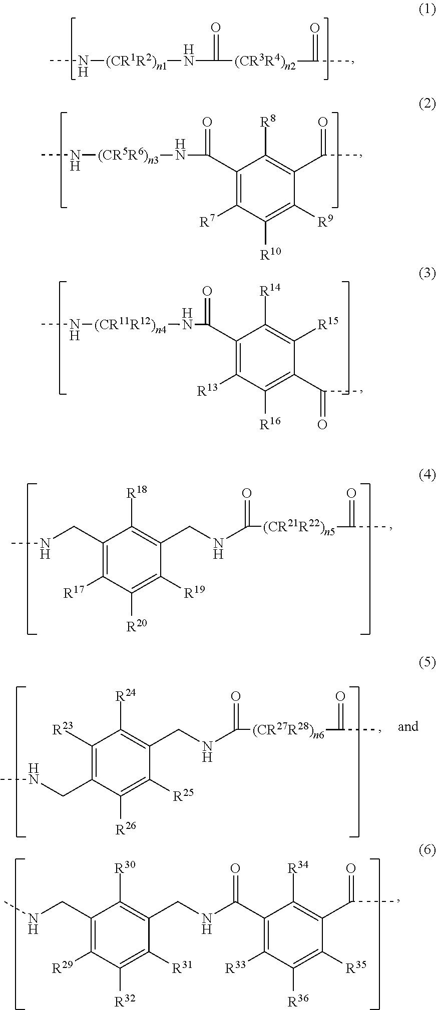

where R¹ to R⁶, R¹¹, R¹², R²¹, R²², R²⁷ and R²⁸, at each location, and R⁷ to R¹⁰, R¹³ to R²⁰, R²³ to R²⁶ and R²⁹ to R³⁶, are independently selected from the group consisting of a hydrogen, a halogen, an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium; n₁, n₃, and n₄ are independently selected integers from 4 to 12, preferably from 4 to 10; and n₂, n₅, and n₆ are independently selected integers from 4 to 12, preferably from 4 to 10. In some embodiments, R¹ to R⁶, R¹¹, R¹², R²¹, R²², R²⁷ and R²⁸, at each location, and R⁷ to R¹⁰, R¹³ to R²⁰, R²³ to R²⁶ and R²⁹ to R³⁶ are all H. Additionally or alternatively, in some embodiments, n₁ to n₆ are all 6.

In some embodiments, recurring unit (R_{PA}) is represented by Formula (1). In some such embodiments, R¹ to R⁴, at each location, is H. Additionally or alternatively, in some embodiments, either n₁ is 5 or 6, n₂ is 10 or both. Examples of desirable polyamide polymers having a recurring unit (R_{PA}) represented by Formula (1) include, but are not limited to PA4,6; PA5,6; PA4,10; PA5,10; PA6,10; PA10,10; and PA10,12.

In some embodiments, recurring unit (R_{PA}) is represented by Formula (2) or (3). In some such embodiments, R⁵, R⁶, R¹¹ and R¹², at each location, and R⁷ to R¹⁰ and R¹³ to R¹⁶ are all H. Additionally or alternatively, in some embodiments, n₃ and n₄ are independently selected integers from 4 to 10, preferably 6. Examples of desirably polyamide polymers having a recurring unit (R_{PA}) represented by either Formula (2) or (3) include, but are not limited to, PA4,T; PA5,T; PA6,T; PA8,T; PA9,T; PA10,T; PA4,I; PA5,I; PA6,I; PA8,I,T; PA9,I and PA10,I.

In some embodiments, recurring unit (R_{PA}) is represented by either Formula (4) or (5). In some such embodiments, R²¹, R²², R²⁷ and R²⁸, at each location, and R¹⁷ to R²⁰ and R²³ to R²⁶ are all H. Additionally or alternatively, in some embodiments, n₅ and n₆ are independently selected integers from 6 to 10, preferably either 6 or 10. Examples of desirable polyamide polymers having recurring unit (R_{PA}) represented by either Formula (4) or (5) include, but are not limited to, MXD6, MXD10, PXD6 and PXD10.

In some embodiments, the polyamide polymer includes additional recurring units, where each additional recurring unit is represented by a formula selected from the group consisting of Formulae (1) to (5). In such embodiments, each additional recurring unit is distinct from each other, as well as from recurring unit (R_{PA1}). In a first such embodiment, the polyamide polymer includes either (i) recurring unit (R_{PA1}) represented by Formula (3) and a recurring unit (R_{PA2}) represented by Formula (2) or (3); or (ii) recurring unit (R_{PA1}) represented by Formula (3), a recurring unit (R_{PA2}) represented by Formula (2) and a recurring unit (R_{PA3}) represented by Formula (1). Examples of the aforementioned embodiment include, but are not limited to, PA6,I/6,6; PA 6,T/6,6; and PA 6,T/6,I/6,6. In some of the aforementioned first embodiments, the molar concentration of recurring unit (R_{PA1}) is greater than or equal to, preferably greater than, the total molar concentration of recurring unit (R_{PA2}) and recurring unit (R_{PA3}), where the molar concentration of recurring unit (R_{PA3}) is zero if recurring unit (R_{PA3}) is not present.

In another embodiment, in which the polyamide polymer includes additional recurring units as described above, the polyamide polymer includes recurring unit (R_{PA1}) according to Formula (4) and a recurring unit (R_{PA2}) according to Formula (5) or Formula (6). Examples of such an embodiment include, but are not limited to, MXD6/PXD6 and MXD6/MXDI.

In embodiments in which the polyamide polymer includes additional recurring units as described above, the total molar concentration of recurring units represented by a Formula (1) to (5) (including recurring unit (R_{PA1})) is more than 50 mol %, relative to the total number of moles of recurring units in the polyamide polymer. Additionally or alternatively, in some such embodiments, the total molar concentration of recurring units represented by a Formula (1) to (5) is at least 60 mol %, at least 70 mol %, at least 80 mol %, at least 90 mol %, or at least 99 mol %, relative to the total number of moles of recurring units in the polyamide polymer.

In some embodiments, the concentration of the polyamide polymer is at least 20 wt. %, at least 25 wt. %, at least 30 wt. %, or at least 35 wt. %. In some embodiments, the concentration of the polyamide polymer is no more than 75 wt. %, no more than 70 wt. %, no more than 65 wt. %, or no more than 60 wt. %. In some embodiments, the concentration of the polyamide polymer is form 20 wt. % to 75 wt. %, from 25 wt. % to 70 wt. %, from 30 wt. % to 65 wt. % or from 35 wt. % to 60 wt. %. As used herein, wt. % is relative to the total weight of the polyamide polymer composition, unless explicitly noted otherwise.

Of course the polyamide polymer composition can include a plurality of distinct polyamide polymers. For example, in some embodiments, the polyamide polymer composition includes a plurality of distinct polyamide polymers, each having more than 50 mol % of a recurring unit according to a formula selected from the group of formulae consisting of Formulae (1) to (6). In some such embodiments, each distinct polyamide polymer has more than 50 mol % of a distinct recurring unit according to a formula selected from the group of formulae consisting of Formulae (1) to (6). In embodiments in which the polyamide polymer composition includes a plurality of distinct polyamide polymers, the total concentration of the polyamide polymers is within the ranges described above.

In some embodiments, the polyamide polymer has an inherent viscosity that is suitable for injection molding processes, though polyamide polymers having a lower inherent viscosity can be used. In some embodiments, the polyamide polymer has an inherent viscosity from 0.7 dL/g to 1.4 dL/g, preferably 0.6 dL/g to 1.2 dL/g, as measured according to ASTM D5336.

In some embodiments, the polyamide polymer has a melting point of from about 180° C. to 340° C. In some embodiments, the polyamide polymer has a melting point from 115° C. to 180° C. Melting point can be measured using differential scanning calorimetry (“DSC”) according to ISO-11357-3.

### Long Reinforcing Fiber

The polyamide polymer composition includes a long reinforcing fiber. As used herein, long reinforcing fibers are reinforcing fibers that have a length of at least 6 millimeters (“mm”). The fibers can be made from various types of materials, though glass fibers are preferred. Additionally, the glass fibers can have a wide variety of dimensions.

In some embodiments, the long reinforcing fiber has a length of at least 8 mm or at least 10 mm. Additionally or alternatively, in some embodiments the long reinforcing fiber has a length of no more than 30 mm, no more than 25 mm, no more than 20 mm, or no more than 15 mm. In some embodiments, the long reinforcing fibers have a length of from 6 mm to 30 mm, from 8 mm to 25 mm, from 8 mm to 20 mm, from 8 mm to 15 mm or from 10 mm to 15 mm. In some embodiments, the long reinforcing fiber has a length of from 6 mm to 15 mm.

The long reinforcing fiber can be in the form of a monofilament or a roving. Rovings are characterized as a bundle of monofilaments that are bound together, in some instances, using a binder. As explained below, in one embodiment, the polymer compositions can be formed using pultrusion, where the long reinforcing fiber (as a monofilament or roving) is pulled through a molten polymer resin (or molten blend of polymer resins).

The composition of the reinforcing fiber is not particularly limited and can be an inorganic fiber or an organic fiber. Examples of desirable reinforcing fibers include, but are not limited to, glass fiber, carbon fiber, synthetic polymeric fiber, aramid fiber, aluminum fiber, titanium fiber, magnesium fiber, aluminum silicate fiber, silicium carbide fiber, boron carbide fiber, rock wool fiber, and steel fiber. Preferably, the reinforcing fiber is glass fiber or carbon fiber, most preferably glass fiber.

As noted above, in some embodiments, the reinforcing fiber is a glass fiber. Glass fibers are silica-based glass compounds that contain several metal oxides which can be tailored to create different types of glass. The main oxide is silica in the form of silica sand; the other oxides such as calcium, sodium and aluminium are incorporated to reduce the melting temperature and impede crystallization. Glass fibers may have a round cross-section or a non-circular cross-section (so called “flat glass fibers”), including oval, elliptical or rectangular. The glass fibers can be added as endless fibers or as chopped glass fibers. The glass fibers have generally an equivalent diameter of 5 to 20 preferably of 5 to 15 μm and more preferably of 5 to 10 μm. All glass fiber types, such as A, C, D, E, M, S, R, T glass fibers (as described in chapter 5.2.3, pages 43-48 of Additives for Plastics Handbook, 2nd ed, John Murphy), or any mixtures thereof or mixtures thereof may be used.

E, R, S and T glass fibers are well known in the art. They are notably described in Fiberglass and Glass Technology, Wallenberger, Frederick T.; Bingham, Paul A. (Eds.), 2010, XIV, chapter 5, pages 197-225. R, S and T glass fibers are composed essentially of oxides of silicon, aluminium and magnesium. In particular, those glass fibers comprise typically from 62-75 wt. % of SiO2, from 16-28 wt. % of Al2O3 and from 5-14 wt. % of MgO. To the contrary of the regular E-glass fibers widely used in polymer compositions, R, S and T glass fibers comprise less than 10 wt. % of CaO. Excellent results were obtained with E-glass fibers and high modulus glass fibers.

In some embodiments, the glass fiber is a high modulus glass fiber. High modulus glass fibers have an elastic modulus of at least 76, preferably at least 78, more preferably at least 80, and most preferably at least 82 GPa as measured according to ASTM D2343. Examples of high modulus glass fibers include, but are not limited to, S, R, and T glass fibers. A commercially available source of high modulus glass fibers is S-2 Glass® Rovings Chopped Strands from AGY.

The morphology of the reinforcing fiber is not particularly limited. In embodiments, in which the reinforcing fiber is a glass fiber, it can have a circular cross-section (“round glass fiber”) or a non-circular cross-section (“flat glass fiber”). Examples of suitable flat glass fibers include, but are not limited to, glass fibers having oval, elliptical and rectangular cross sections. In some embodiments, polyamide polymer compositions including long reinforcing fibers that are high modulus flat glass fiber can be especially desirable. In particular, in such embodiments, synergistic effects deriving from the inherently high mechanical properties of the flat glass fibers and the inherently high mechanical properties of the long glass fiber can be achieved.

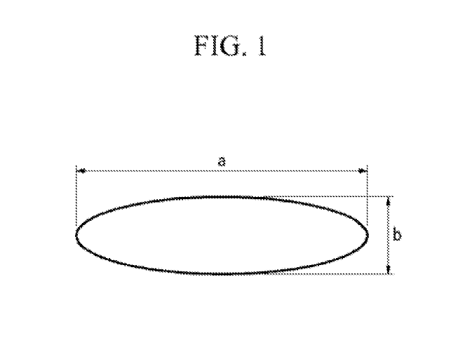

In some embodiments in which the polyamide polymer composition includes a flat glass fiber, the flat glass fiber has a cross-sectional longest diameter (e.g. “a” in FIG. 1) of at least 15 μm, preferably at least 20 μm, more preferably at least 22 μm, still more preferably at least 25 μm. Additionally or alternatively, in some embodiments, the flat glass fiber has a cross-sectional longest diameter of at most 40 μm, preferably at most 35 μm, more preferably at most 32 μm, still more preferably at most 30 μm. In some embodiments, the flat glass fiber has a cross-sectional diameter was in the range of 15 to 35 μm, preferably of 20 to 30 μm and more preferably of 25 to 29 μm.

In some embodiments, the flat glass fiber has a cross-sectional shortest diameter (e.g. “b” in FIG. 1) of at least 4 μm, preferably at least 5 μm, more preferably at least 6 μm, still more preferably at least 7 μm. Additionally or alternatively, in some embodiments, the flat glass fiber has a cross-sectional shortest diameter of at most 25 μm, preferably at most 20 μm, more preferably at most 17 μm, still more preferably at most 15 μm. In some embodiments, the flat glass fiber has a cross-sectional shortest diameter was in the range of 5 to 20 preferably of 5 to 15 μm and more preferably of 7 to 11 μm.

In some embodiments, the flat glass fiber has an aspect ratio of at least 2, preferably at least 2.2, more preferably at least 2.4, still more preferably at least 3. Referring to FIG. 1, the aspect ratio is defined as a ratio of the longest diameter (a) in the cross-section of the glass fiber to the shortest diameter (b) thereof. Additionally or alternatively, in some embodiments, the flat glass fiber has an aspect ratio of at most 8, preferably at most 6, more preferably of at most 4. In some embodiments, the flat glass fiber has an aspect ratio of from 2 to 6, and preferably, from 2.2 to 4.

In some embodiments, in which the glass fiber is a round glass fiber, the glass fiber has an aspect ratio of less than 2, preferably less than 1.5, more preferably less than 1.2, even more preferably less than 1.1, most preferably, less than 1.05. Of course, the person of ordinary skill in the art will understand that regardless of the morphology of the glass fiber (e.g. round or flat), the aspect ratio cannot, by definition, be less than 1.

In some embodiments, the concentration of the long reinforcing fiber is at least 10 wt. %, at 15 wt. %, at least 20 wt. %, at least 25 wt. % or at least 30 wt. %. Additionally or alternatively, in some embodiments, the concentration of the long reinforcing fiber is no more than 80 wt. %, no more than 75 wt. %, no more than 70 wt. %, no more than 65 wt. % or no more than 60 wt. %. In some embodiments, the concentration of the reinforcing fiber is from 10 wt. % to 80 wt. %, from 15 wt. % to 75 wt. %, from 20 wt. % to 70 wt. %, from 25 wt. % to 65 wt. %, or from 30 wt. % to 60 wt. %. Of course, the polyamide polymer composition can include a plurality of distinct long reinforcing fibers. In such embodiments, the total concentration of long reinforcing fibers is within the ranges described above.

### Heat Stabilizer

The polyamide polymer composition includes a heat stabilizer. The is selected to provide increased thermo-oxidative stability to the polyamide polymer. In general, the heat stabilizer aids in preventing thermo-oxidative decomposition of the polyamide polymer at or above 200° C.

In some embodiments, the heat stabilizer is selected from elemental iron and a polyhydric alcohol. The type of heat stabilizer can be selected with respect to the polyamide polymer as well as the intended application setting. For example, elemental iron provides desirable thermo-oxidative stability to the polyamide polymer up to temperatures of no more than 250° C., or no more than 230° C. On the other hand, polyhydric alcohols provide desirable thermo-oxidative stability to the polyamide polymer up to temperatures of no more than about 200° C. Accordingly, based upon the T_{g} of the polyamide polymer and the intended application setting, the person of ordinary skill in the art will know how to select desirable heat stabilizers in light of the present disclosure.

With respect to element iron, it's use in polyamide compositions is described in PCT patent application publication number WO 2012/168442 (“the '442 application”) to Norfolk, filed Jun. 8, 2012 and incorporated herein by reference. In some embodiments, the elemental iron is preferably in the form of particles, the majority of which having a small particle size, such as a powder. In some such embodiments, the elemental iron has a weight average particle size of at most 450 μm, at most 200 μm, at most 150 μm, at most 100 μm, at most 50 μm, or at most 25 μm. Additionally or alternatively, in some embodiments, the elemental iron has a weight average particle size of at least 0.5 μm, at least 1 μm, at least 5 μm, at least 10 μm, at least 13 μm, at least 15 μm, at least 18 μm or at least 20 μm. In some embodiments, the elemental iron has a weight average particle size of from 0.5 μm to 450 μm, from 1 μm to 200 μm, from 5 μm to 150 μm, from 10 μm to 50 μm, from 13 μm to 25 μm, from 15 μm to 18 μm or from 20 μm to 25 μm. In some embodiments, the element iron has a weight average particle size of from 10 μm to 50 μm, from 15 μm to 45 μm, from 20 μm to 40 μm or from 25 μm to 35 μm. In some embodiments, the elemental iron has a weight average particle size of from 0.5 μm to 25 μm, from 0.5 μm to 20 μm, from 1 μm to 20 μm, from 1 μm to 15 μm, or from 1 μm to 10 μm. The weight average particle size is determined as Dₘ according to ASTM standard D1921-89, method A.

Preferably the size, to be understood as the largest dimension, of at least 99 wt. % of the elemental iron particles is at most 450 μm, at most 200 μm, at most 100 μm, at most 90 μm, at most 80 μm or at most 70 μm. Preferably the size, to be understood as the smallest dimension, of at least 99 wt. % of the elemental iron particles is at least 0.5 μm, at least 1 μm, at least 10 μm, preferably at least 15 μm, most preferably at least 20 μm or most preferably at least 25 μm.

The concentration of the elemental iron in the polyamide polymer composition can vary over a wide range, while still providing effective thermo-oxidative stabilization to the polyamide polymer. Thought, the elemental iron provides a significant thermos-oxidative stabilization effect even at low concentrations. In some embodiments, the concentration of the elemental iron is at least 0.1 wt. %, preferably at least 0.2 wt. %, more preferably at least 0.5 wt. %, even more preferably at least 0.9 wt. % or most preferably at least 1.0 wt. %. Additionally or alternatively, in some embodiments, the concentration of the elemental iron is at most 10 wt. %. Higher elemental iron concentrations may be used, however without any additional appreciable effect on the heat stability of the polyamide polymer. In some embodiments, the concentration of the elemental iron is at most 5 wt. %, at most 4 wt. %, at most 3 wt. % or at most 2.5 wt. %. Advantageously, the elemental iron concentration is from 0.1 wt. % to 5 wt. %, from 0.5 wt. % to 3 wt. %, or from 0.9 wt. % to 2.5 wt. %.

In some embodiments, the elemental iron is incorporated into the polyamide polymer composition in conjunction with a small amount of either PA 6; PA 6,6 or both, as a co-additive (“aliphatic polyamide co-additive”). In some embodiments, in which the heat stabilizer is elemental iron, the polyamide polymer composition further includes at least 1 wt. %, at least 2 wt. % at least 2.5 wt. %, at least 3 wt. %, at least 3.5 wt. % or at least 4 wt. % of the aliphatic polyamide co-additive. Additionally or alternatively, in some embodiments in which the heat stabilizer is elemental iron, the polyamide polymer composition further includes at most 20 wt. %, at most 18 wt. %, at most 16 wt. %, at most 14 wt. % or at most 12 wt. % of the aliphatic polyamide polymer co-additive.

With respect to polyhydric alcohols, their use as thermo-oxidative stabilizers is described in US patent application publication number US 2010/0029820 (“the '820 application”) to Palmer et al., filed Jul. 30, 2009 and incorporated herein by reference. Polyhydric alcohols are a class of polyols. The polyhydric alcohols of interest herein include aliphatic hydroxylic compounds including more than two hydroxyl groups, aliphatic-cycloaliphatic compounds containing more than two hydroxyl groups, cycloalipahatic compounds containing more than two hydroxyl groups, aromatic and saccharaides. Examples of desirable polyhydric alcohols include, but are not limited to, triols, such as glycerol, trimethylolpropane, 2,3-di-(2′-hydroxyethyl)-cyclohexan-1-ol, hexane-1,2,6-triol, 1,1,1-tris-(hydroxymethyl)ethane, 3-(2′-hydroxyethoxy)-propane-1,2-diol, 3-(2′-hydroxypropoxy)-propane-1,2-diol, 2-(2′-hydroxyethoxy)-hexane-1,2-diol, 6-(2′-hydroxypropoxy)-hexane-1,2-diol, 1,1,1-tris-[(2′-hydroxyethoxy)-methyl]-ethane, 1,1,1-tris-[(2′-hydroxypropoxy)-methyl]-propane, 1,1,1-tris-(4′-hydroxyphenyl)-ethane, 1,1,1-tris-(hydroxyphenyl)-propane, 1,1,3-tris-(dihydroxy-3-methylphenyl)-propane, 1,1,4-tris-(dihydroxyphenyl)-butane, 1,1,5-tris-(hydroxyphenyl)-3-methylpentane, di-trimethylopropane, trimethylolpropane ethoxylates, or trimethylolpropane propoxylates; saccharides, such as cyclodextrin, D-mannose, glucose, galactose, sucrose, fructose, xylose, arabinose; and sugar alcohols such as D-mannitol, D-sorbitol, D- or L-arabitol, xylitol, iditol, talitol, allitol, altritol, guilitol, erythritol, pentaerythritol, dipentaerythritol, and tripentaerythritol, threitol, and D-gulonic-y-lactone; and the like.

In embodiments in some embodiments in which the heat stabilizer is a polyhydric alcohol, the concentration of the polyhydric alcohol is at least 0.1 wt. %, at least 0.2 wt. %, at least 1 wt. %, at least 2 wt. % or at least 2.5 wt. %. Additionally or alternatively, in some embodiments, the concentration of the polyhydric alcohol is no more than 20 wt. %, no more than 15 wt. %, no more than 8 wt. % or no more than 5 wt. %. In some embodiments, the concentration of the polyhydric alcohol is from 0.1 wt. % to 20 wt. %, from 0.2 wt. % to 15, from 1 wt. % to 8 wt. % or from 2 wt. % to 5 wt. %. Of course, the polyamide can include a plurality of distinct polyhydric alcohols. In such embodiments, the total concentration of the polyhydric alcohol is within the ranges described above.

### Additives

The polyamide polymer composition can optionally include an additive. The additive can be selected from the group consisting of ultraviolet light stabilizers, acid scavengers (i.e. zinc oxide, magnesium oxide), pigments, processing aids, lubricants, flame retardants, and/or conductivity additive (i.e. carbon black and carbon nanofibrils). In some embodiments, the polymer composition can include a flame retardant including, but not limited to, halogen and halogen free flame retardants. Of course, the polyamide polymer composition can include a plurality of distinct additives. For clarity, additives do not include the heat stabilizers described above.

When present the total concentration of additives is at least 0.1 wt. % or at least 0.5 wt. %. Additionally or alternatively, in some embodiments, the concentration of the additives is no more than 40 wt. %, no more than no more than 10 wt. %, no more than 5 wt. % or no more than 1 wt. %. In some embodiments, the concentration of the additives is from 0.1 wt. % to 25 wt. % or from 0.5 wt. % to 10 wt. %.

In some embodiments in which the polyamide polymer composition includes a pigment as an additive, the concentration of the pigment is at least 1 wt. %, at least 2 wt. % or at least 3 wt %. Additionally or alternatively, the concentration of the pigment is no more than 35 wt. %, no more than 20 wt. %, no more than 10 wt. %, or no more than 8 wt. %. In some embodiments, the concentration of the pigment is from 0.1 wt. 5 to 35 wt. %, from 1 wt. % to 20 wt. %, from 2 wt. % to 10 wt. %, or from 3 wt. % to 8 wt. %. In some embodiments, the pigment is a white pigment selected from the group containing titanium dioxide, barium sulfate, zinc sulfide and mixtures thereof. Preferably, the white pigment is titanium dioxide or zinc sulfide.

### Formation Methods and Articles

The polymer compositions can be formed using melt processing methods. In one embodiment, the polymer composition is formed using pultrusion. In a pultrusion process, the reinforcing fiber is pulled through an impregnation block including a molten polymer composition. For example, with respect to the presently described polyamide polymer composition, the molten polymer composition includes the components of the polyamide polymer composition except for, of course, the reinforcing fiber. Within the impregnation block, the reinforcing fibers are contacted with the molten polymer composition to impregnate the reinforcing fibers with the molten polymer composition.

Exiting the block, the polyamide polymer composition can be cut into pellets of a desired length. While the length of the pellets is not particularly limited, in some embodiments, the pellets are cut into lengths of at least 6 mm, at least 8 mm or at least 10 mm. Additionally or alternatively, in some embodiments the pellets are cut into lengths of no more than 30 mm, no more than 25 mm, no more than 20 mm, or no more than 15 mm. In some embodiments, the pellets are cut into lengths of from 6 mm to 30 mm, from 8 mm to 25 mm, from 8 mm to 20 mm, from 8 mm to 15 mm or from 10 mm to 15 mm. In some embodiments, the pellets are cut into lengths of from 6 mm to 15 mm. Of course the reinforcing fiber entering the impregnation block must be at least as long the desired pellet length. In some embodiments, the reinforcing fiber is fed, directly or indirectly, into the impregnation block from a large spool onto which a continuous reinforcing fiber is wound.

In some embodiments, the pellets can be used to form articles. In some such embodiments, the pellets can be melt processed using techniques well known in the art to from the articles. For example, the pellets can be melted and injected or blow-molded to form the desired articles. Desirable articles include, but are not limited to, automotive parts in high heat application settings including, but not limited to, turbocharger components (e.g. volutes, compressor housings, turbine housings, and compressor and turbine fan components) engine covers, battery covers, battery casing, connectors, fan blades and fan housings, fluid pump housings and components, led housing, trays and pans, screw caps, fluid reservoirs (e.g. windshield washer fluid reservoirs).

### Further Inventive Concepts

Described below are specific, non-limiting inventive concepts. The person of ordinary skill in the art will recognize that each combination of the elements of any linked inventive concepts, including any explicitly described species within an explicitly described genus and any value within an explicitly stated range, is specifically contemplated and within the scope of the present disclosure.

1. A polymer compositions comprising
20 wt. % to 75 wt. % of a polyamide polymer;
10 wt. % to 75 wt. % of a long reinforcing fiber; and
0.1 wt. % to 20 wt. % of a heat stabilizer.
   2. The polymer composition of inventive concept 1, wherein the polyamide polymer comprises, relative to the total number of moles of recurring units in the polyamide polymer, more than 50 mol % of a recurring unit (R_{PA}) represented by a formula selected from the following group of formulae:

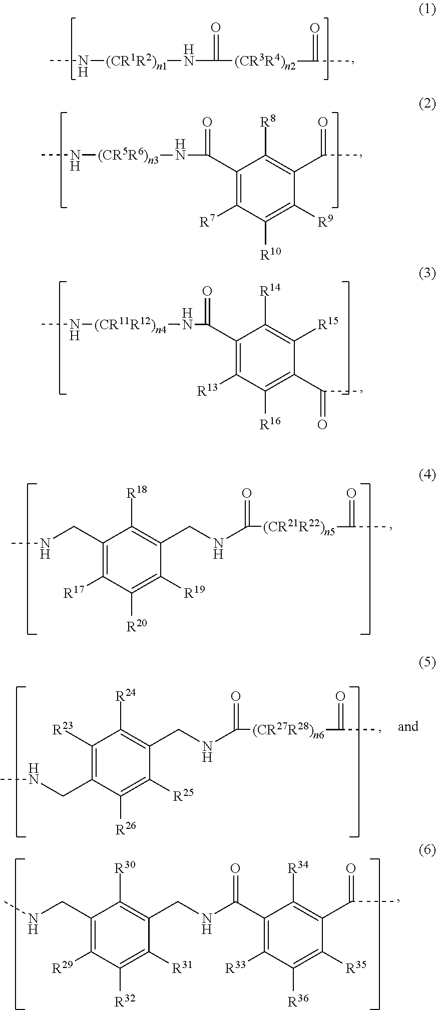

wherein
R¹ to R⁶, R¹¹, R¹², R²¹, R²², R²⁷ and R²⁸, at each location, and R⁷ to R¹⁰, R¹³ to R²⁰, R²³ to R²⁶ and R²⁹ to R³⁶, are independently selected from the group consisting of a hydrogen, a halogen, an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium; preferably R¹ to R⁶, R¹¹, R¹², R²¹, R²², R²⁷ and R²⁸, at each location, and R⁷ to R¹⁰, R¹³ to R²⁰, R²³ to R²⁶ and R²⁹ to R³⁶ are all hydrogen;
n₁, n₃, and n₄ are independently selected integers from 4 to 12, preferably from 4 to 10; and
n₂, n₅, and n₆ are independently selected integers from 4 to 12, preferably from 4 to 10.
   3. The polymer composition inventive concept 2, wherein the heat stabilizer is elemental iron.
   4. The polymer composition of inventive concept 3, wherein the polymer composition further comprises PA6 or PA6,6.
   5. The polymer composition of inventive concept 4, wherein the long reinforcing fiber is glass fiber or carbon fiber, most preferably glass fiber.
   6. The polymer composition of inventive concept 5, wherein the glass fiber comprises a high modulus glass fiber.
   7. The polymer composition of inventive concept 5 or 6, wherein the glass fiber is a round glass fiber or a flat glass fiber, preferably a round glass fiber
   8. The polymer composition of inventive concept 7, wherein the concentration of the elemental iron is from 0.1 wt. % to 5 wt. %, preferably from 0.5 wt. % to 3 wt. %, most preferably from 0.9 wt. % to 2.5 wt. %.
   9. The polymer composition of inventive concept 8, wherein the elemental iron has a weight average particle size from at least 1 μm, preferably from at least 10 μm, to no more than 450 μm, preferably no more than 200 μm, more preferably no more than 150 μm, even more preferably no more than 100 μm, still more preferably no more than 50 μm, and most preferably 10 μm.
   10. The polymer composition of inventive concept 9, wherein the at least 99 wt. % of the elemental iron particles have a largest dimension of at most 450 μm, at most 200 μm, at most 100 μm, at most 90 μm, at most 80 μm or at most 70 μm and a smallest dimension of at least 10 μm, preferably at least 15 μm, more preferably at least 20 m or most preferably at least 25 μm.
   11. The polymer composition of inventive concept 10, wherein recurring unit (R_{PA}) is represented by Formula (1).
   12. The polymer composition of inventive concept 11, wherein R¹ to R⁴, at each location, is a hydrogen.
   13. The polymer composition of inventive concept 12, wherein the polyamide polymer is selected from the group consisting of PA4,6; PA5,6; PA4,10; PA5,10; PA6,10; PA10,10; and PA10,12.
   14. The polymer composition of inventive concept 10, wherein recurring unit (R_{PA}) is represented by Formula (2) or (3).
   15. The polymer composition of inventive concept 14, wherein R⁵, R⁶, R¹¹, and R¹² at each location, and R⁷ to R¹⁰ and R¹³ to R¹⁶ are all hydrogen.
   16. The polymer composition of inventive concept 15, wherein the polyamide polymer is selected from the group consisting of PA4,T; PA5,T; PA6,T; PA8,T; PA9,T; PA10,T; PA4,I; PA5,I; PA6,I; PA8,I,T; PA9,I and PA10,I.
   15. The polymer composition of inventive concept 10, wherein recurring unit (R_{PA}) is represented by Formula (4) or (5).
   16. The polymer composition of inventive concept 15, wherein R²¹, R²², R²⁷, and R²⁸ at each location, and R¹⁷ to R²⁰ and R²³ to R²⁶ are all hydrogen.
   17. The polymer composition of inventive concept 16, wherein the polyamide polymer is selected from the group consisting of MXD6, MXD10, PXD6 and PXD10.
   18. The polymer composition of inventive concept 10, wherein the polyamide polymer is selected from the group consisting of PA6,I/6,6; PA 6,T/6,6; and PA 6,T/6,I/6,6.
   19. The polymer composition of inventive concept 10, wherein the polyamide polymer is selected from the group consisting of MXD6/PXD6 and MXD6/MXDI.
   20. The polymer composition inventive concept 2, wherein the heat stabilizer is a polyhydric alcohol.
   21. The polymer composition of inventive concept 20, wherein the polyhydric alcohol is selected from the group consisting of triols, sugar alcohols, and saccharides.
   22. The polymer composition of inventive concept 21, wherein the polyhydric alcohol is a triol selected from the group consisting of glycerol, trimethylolpropane, 2,3-di-(2′-hydroxyethyl)-cyclohexan-1-ol, hexane-1,2,6-triol, 1,1,1-tris-(hydroxymethyl)ethane, 3-(2′-hydroxyethoxy)-propane-1,2-diol, 3-(2′-hydroxypropoxy)-propane-1,2-diol, 2-(2′-hydroxyethoxy)-hexane-1,2-diol, 6-(2′-hydroxypropoxy)-hexane-1,2-diol, 1,1,1-tris-[(2′-hydroxyethoxy)-methyl]-ethane, 1,1,1-tris-[(2′-hydroxypropoxy)-methyl]-propane, 1,1,1-tris-(4′-hydroxyphenyl)-ethane, 1,1,1-tris-(hydroxyphenyl)-propane, 1,1,3-tris-(dihydroxy-3-methylphenyl)-propane, 1,1,4-tris-(dihydroxyphenyl)-butane, 1,1,5-tris-(hydroxyphenyl)-3-methylpentane, di-trimethylopropane, trimethylolpropane ethoxylates, and trimethylolpropane propoxylates.
   23. The polymer composition of inventive concept 22, wherein the polyhydric alcohol is a sugar alcohol selected form the group consisting of D-mannitol, D-sorbitol, D- or L-arabitol, xylitol, iditol, talitol, allitol, altritol, guilitol, erythritol, pentaerythritol, dipentaerythritol, and tripentaerythritol threitol, and D-gulonic-y-lactone.
   24. The polymer composition of inventive concept 22, wherein the polyhydric alcohol is a saccharides selected from the group consisting of cyclodextrin, D-mannose, glucose, galactose, sucrose, fructose, xylose, and arabinose.
   25. The polymer composition of either one of inventive concepts 21 to 24, wherein the concentration of the polyhydric alcohol is at least 0.1 wt. %, preferably at least 0.2 wt. %, more preferably at least 1 wt. %, even more preferably at least 2 wt. %, or most preferably at least 2.5 wt. %.
   26. The polymer composition of inventive concept 25, wherein the concentration of the polyhydric alcohol is at no more than 20 wt. %, preferably no more than 15 wt. %, still more preferably no more than 8 wt. % or most preferably no more than 5 wt. %.
   27. The polymer composition of either one of inventive concept 26, wherein the long reinforcing fiber is glass fiber.
   28. The polymer composition of inventive concept 27, wherein the glass fiber comprises a high modulus glass fiber.
   29. The polymer composition of inventive concept 27 or 28, wherein the glass fiber is a round glass fiber or a flat glass fiber, preferably a round glass fiber.
   30. The polymer composition of inventive concept 29, wherein recurring unit (R_{PA}) is represented by Formula (1).
   31. The polymer composition of inventive concept 30, wherein R¹ to R⁴, at each location, is a hydrogen.
   32. The polymer composition of inventive concept 31, wherein the polyamide polymer is selected from the group consisting of PA4,6; PA5,6; PA4,10; PA5,10; PA6,10; PA10,10; and PA10,12.
   33. The polymer composition of inventive concept 29, wherein recurring unit (R_{PA}) is represented by Formula (2) or (3).
   34. The polymer composition of inventive concept 33, wherein R⁵, R⁶, R¹¹, and R¹² at each location, and R⁷ to R¹⁰ and R¹³ to R¹⁶ are all hydrogen.
   35. The polymer composition of inventive concept 34, wherein the polyamide polymer is selected from the group consisting of PA4,T; PA5,T; PA6,T; PA8,T; PA9,T; PA10,T; PA4,I; PA5,I; PA6,I; PA8,I,T; PA9,I and PA10,I.
   36. The polymer composition of inventive concept 29, wherein recurring unit (R_{PA}) is represented by Formula (4) or (5).
   37. The polymer composition of inventive concept 36, wherein R²¹, R²², R²⁷, and R²⁸ at each location, and R¹⁷ to R²⁰ and R²³ to R²⁶ are all hydrogen.
   38. The polymer composition of inventive concept 37, wherein the polyamide polymer is selected from the group consisting of MXD6, MXD10, PXD6 and PXD10.
   39. The polymer composition of inventive concept 29, wherein the polyamide polymer is selected from the group consisting of PA6,I/6,6; PA 6,T/6,6; and PA 6,T/6,I/6,6.
   40. The polymer composition of inventive concept 29, wherein the polyamide polymer is selected from the group consisting of MXD6/PXD6 and MXD6/MXDI.

1. A polyamide polymer compositions comprising
20 wt. % to 75 wt. % of a polyamide polymer;
10 wt. % to 75 wt. % of a long reinforcing fiber; and
0.1 wt. % to 20 wt. % of a heat stabilizer.

2. The polymer composition of claim 1, wherein the polyamide polymer comprises, relative to the total number of moles of recurring units in the polyamide polymer, more than 50 mol % of a recurring unit (R_{PA}) represented by a formula selected from the following group of formulae: 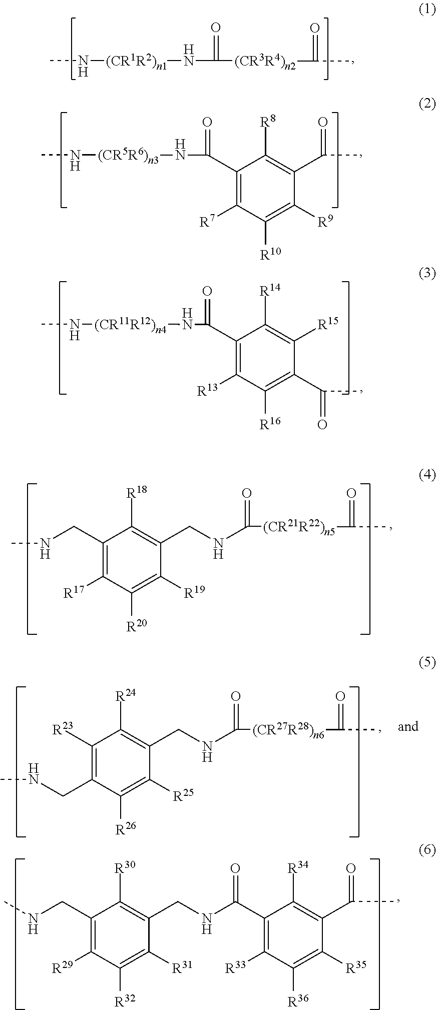
wherein
R¹ to R⁶, R¹¹, R¹², R²¹, R²², R²⁷ and R²⁸, at each location, and R⁷ to R¹⁰, R¹³ to R²⁰, R²³ to R²⁶ and R²⁹ to R³⁶, are independently selected from the group consisting of a hydrogen, a halogen, an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium; preferably R¹ to R⁶, R¹¹, R¹², R²¹, R²², R²⁷ and R²⁸, at each location, and R⁷ to R¹⁰, R¹³ to R²⁰, R²³ to R²⁶ and R²⁹ to R³⁶ are all hydrogen;
n₁, n₃, and n₄ are independently selected integers from 4 to 12, preferably from 4 to 10; and
n₂, n₅, and n₆ are independently selected integers from 4 to 12, preferably from 4 to 10.

3. The polymer composition of claim 1, wherein the heat stabilizer is elemental iron having a weight average particle size of at least 1 μm.

4. The polymer composition of claim 1, wherein the heat stabilizer is a polyhydric alcohol.

5. The polymer composition of claim 4, wherein the polyhydric alcohol is a triol selected from the group consisting of glycerol, trimethylolpropane, 2,3-di-(2′-hydroxyethyl)-cyclohexan-1-ol, hexane-1,2,6-triol, 1,1,1-tris-(hydroxymethyl)ethane, 3-(2′-hydroxyethoxy)-propane-1,2-diol, 3-(2′-hydroxypropoxy)-propane-1,2-diol, 2-(2′-hydroxyethoxy)-hexane-1,2-diol, 6-(2′-hydroxypropoxy)-hexane-1,2-diol, 1,1,1-tris-[(2′-hydroxyethoxy)-methyl]-ethane, 1,1,1-tris-[(2′-hydroxypropoxy)-methyl]-propane, 1,1,1-tris-(4′-hydroxyphenyl)-ethane, 1,1,1-tris-(hydroxyphenyl)-propane, 1,1,3-tris-(dihydroxy-3-m ethylphenyl)-propane, 1,1,4-tris-(dihydroxyphenyl)-butane, 1,1,5-tris-(hydroxyphenyl)-3-methylpentane, di-trimethylopropane, trimethylolpropane ethoxylates, and trimethylolpropane propoxylates.

6. The polymer composition of claim 4, wherein the polyhydric alcohol is a sugar alcohol selected form the group consisting of D-mannitol, D-sorbitol, D- or L-arabitol, xylitol, iditol, talitol, allitol, altritol, guilitol, erythritol, pentaerythritol, dipentaerythritol, and tripentaerythritol threitol, and D-gulonic-y-lactone.

7. The polymer composition of claim 4, wherein the polyhydric alcohol is a saccharide selected from the group consisting of cyclodextrin, D-mannose, glucose, galactose, sucrose, fructose, xylose, and arabinose.

8. The polymer composition of claim 1, wherein the long reinforcing fiber is a round glass fiber or a flat glass fiber.

9. The polymer composition of claim 8, wherein the glass fiber comprises a high modulus glass fiber.

10. The polymer composition of claim 2, wherein recurring unit (R_{PA}) is represented by Formula (1) and wherein R¹ to R⁴, at each location, is a hydrogen.

11. The polymer composition of claim 2, wherein recurring unit (R_{PA}) is represented by Formula (2) or (3) and wherein R⁵, R⁶, R¹, and R¹² at each location, and R⁷ to R¹⁰ and R¹³ to R¹⁶ are all hydrogen.

12. The polymer composition of claim 2, wherein recurring unit (R_{PA}) is represented by Formula (4) or (5) and wherein R²¹, R²², R²⁷, and R²⁸ at each location, and R¹⁷ to R²⁰ and R²³ to R²⁶ are all hydrogen.

13. The polymer composition of claim 1, wherein the polyamide polymer is selected from the group consisting of MXD6, MXD10, PXD6, and PXD10.

14. The polymer composition of claim 1, wherein the polyamide polymer is selected from the group consisting of PA6,I/6,6; PA 6,T/6,6; and PA 6,T/6,I/6,6.

15. The polymer composition of claim 1, wherein the polyamide polymer is selected from the group consisting of MXD6/PXD6 and MXD6/MXDI.

16. An article comprising the polymer composition of claim 1, wherein the article is an automotive part selected from the group consisting of turbocharger components, engine covers, battery covers, battery casing, connectors, fan blades, fan housings, fluid pump housing, fluid pump components, led housing, trays, pans, screw caps, and fluid reservoirs.

17. The polymer composition of claim 1, wherein the heat stabilizer is elemental iron having a weight average particle size of at least 10 μm.

18. The polymer composition of claim 1, wherein the long reinforcing fiber is a round glass fiber.
